(19) United States
(12) Patent Application Publication
(10) Pub. No.: US 2009/0117945 A1
(43) Pub. Date: May 7, 2009

(54) Hands-Free Device Producing a Spoken Prompt with Spatial Effect

(75) Inventors: Sergio Mahler, Barcelona (ES); Sergi Torrents, Barcelona (ES); Marc Molina, Barcelona (ES); Jean-Regis Ferraton, Barcelona (ES)

Correspondence Address: HAYES, SOLOWAY P.C., 175 CANAL STREET, MANCHESTER, NH, 03101, US

(73) Assignee: SouthWing S.L., Bacelona (ES)

(21) Appl. No.: 11/996,001

(22) PCT Filed: Jul. 21, 2006
(86) PCT No.: PCT/GB2006/002755

§ 371 Date: Jun. 4, 2008

(30) Foreign Application Priority Data
Jul. 21, 2005 (ES) 200501784
Sep. 21, 2005 (GB) 0519315.6

(51) Int. Cl. H04M 1/247; G06F 3/16; G06F 3/048

(52) U.S. Cl. 455/569.1; 715/727; 715/828

(57) ABSTRACT

A hands-free device (1) that is linked via a short range radio frequency (RF) communications link (2) to a mobile communications device (3) supports and provides a number of functions, such as user actions and internal events, such as incoming calls. The user operable functions of the hands-free device (1) are arranged in a hierarchical menu structure that a user can navigate through and around and select from using a user operable input means of the hands-free device (1). Each function or option that can be selected in the menu structure has associated with it a spoken prompt that is automatically provided to the user via the hands-free device (1) when that function is reached in the menu structure.

The present invention relates to personal communications systems, and in particular to hands-free devices for use with communications devices.

It is increasingly common for communications devices, such as mobile phones, mobile radios, personal digital assistants (PDAs), etc., to be used with “hands-free” devices, such as wireless headsets, for convenience and other reasons. In such an arrangement, as is known in the art, the audio signals for an, e.g., telephone call, are routed via the hands-free device, rather than, e.g., being reproduced by the phone itself.

Many hands-free devices provide the facility to control, operate and/or configure, etc., at least to a certain extent, the hands-free device and/or the communications device to which it is coupled. Such functionality is typically provided by one or more user-operable inputs, such as push buttons or rotary switches, on the hands-free device. However, a drawback with such arrangements is that the user typically needs to remember the functions that the inputs on the hands-free device control. This can become increasingly difficult as the possible functions provided by the hands-free device increase in number and complexity. This means that there may be little perceived benefit in providing more and more complex functions on a hands-free device, and/or that users may not use the full functionality provided by a hands-free device.

The Applicants believe therefore that there remains scope for improvement to hands-free devices that may be used with communications devices.

According to a first aspect of the present invention, there is provided a hands-free device for a communications device, comprising:

means for providing a spoken prompt to a user via the hands-free device.

According to a second aspect of the present invention, there is provided a method of operating a hands-free device for a communications device, comprising:

the hands-free device providing a spoken prompt to a user of the hands-free device.

The hands-free device of the present invention provides a spoken prompt to a user (which prompt could, e.g., relate to a function or functions that can be operated via the hands-free device). In other words, the hands-free device can provide spoken feedback in the form of a voice prompt to a user, e.g., advising the user of the functionality of the hands-free device. This will, e.g., help a user to remember and understand the functions provided by the hands-free device and generally improve the interaction experience of the user with the hands-free device.

The Applicants accordingly believe that the arrangement of the present invention will, e.g., facilitate the inclusion of more and more complex functions on a hands-free device, since the user can be better guided through those functions while the hands-free device is in use. The Applicants also believe that using spoken prompts in this manner is preferable to, and advantageous over, using, e.g., simple audio tones or beeps, or visual indicators, as spoken prompts can more readily convey complex information and may be more easily understood by a user.

The hands-free device can be any suitable such device, such as a head-mounted device (e.g. headset, earpiece, helmet, glasses, etc.). It could also, e.g., be an in-car hands-free kit or similar, a desk-top hands-free system, or a system that is worn elsewhere on the body, such as the wrist or embedded in clothing.

The hands-free device may be coupled to and control the communications device in any suitable manner, such as through a wired connection. The link between the hands-free device and the communications device should be such that at least some of the functions of the communications device can be controlled via the hands-free device, and, e.g., such that the user can participate in calls using the hands-free device. In a preferred embodiment, the hands-free device is wirelessly coupled to the communications device, most preferably via a short range RF (radio frequency) link, such as a “Bluetooth” link. Other forms of wireless linking, such as a magnetic induction, or an infra-red, arrangement could also be used.

The communications device that the hands-free device can link to can be any suitable such device, such as a telephone. In a preferred embodiment, the communications device is a mobile communications device, such as a mobile phone or radio, a (mobile communications-enabled) personal digital assistant, a (mobile communications-enabled) laptop or a vehicle mounted communications terminal, etc. In alternative preferred embodiments, the communications device is a digital audio player (e.g. an mp3 or other format digital audio player) or a Global Positioning System (GPS) or other location device or a vending or other machine, or any other suitable consumer electronic device.

Any desired or suitable spoken prompt can be provided to a user in accordance with the present invention. Thus, the prompts could, for example, relate to functions of the hands-free device and/or operable via the hands-free device, such as settings adjustments, menu options available, etc. The prompts could also, e.g., relate to the status or condition of the hands-free device, communications device or communications network to which it is coupled, such as, e.g., provide warnings or information as to the current status of the hands-free device, and/or in response to internal device events or external (e.g. communications system) events.

In a particularly preferred embodiment, the prompts relate to a function or functions operable via, or of, the hands-free device, and/or to the functionality provided by a user input or inputs of the hands-free device. They most preferably provide information about a function or functions of the hands-free device, and/or about the functionality provided by a user input or inputs of the hands-free device. For example, a prompt or the prompts could, and in a preferred embodiment do, describe a function or functions that the hands-free device can currently execute, such as “accept incoming call”.

Spoken prompts relating to, e.g., the status or condition of the hands-free device or of the mobile communications device or system (network) to which it is coupled preferably can be and preferably are also or instead provided. For example, it may be desirable to provide spoken prompts informing a user of the state of charge of a battery of the hands-free device or of the communications device, or of the status of the underlying communications network or communications channel to which the communications device is coupled. In these cases, the status of the status factor or condition could, e.g., be monitored (e.g. by the hands-free device itself, or by the communications device or communications network to which it is coupled), and a spoken prompt indicating the current status provided, e.g., periodically, and/or when the status factor reaches or crosses a given value or threshold or range.

Most preferably at least spoken prompts regarding a function or functions operable via the hands-free device and/or regarding the status or condition of the hands-free device, communications device and/or communications network, can be and are provided.

In a preferred embodiment, prompts can be and preferably are provided in response to user actions, such as, e.g., user operation of an input means of the hands-free device. For example, and preferably, when a user moves in a function menu, a prompt may be provided to inform the user of the option or options he or she can currently select. These prompts may be viewed as providing user-triggered information. Prompts may also or alternatively be and are preferably provided to inform a user when a command or operation has been successfully carried out. Such a prompt may be viewed as a user-triggered verification.

Prompts may alternatively or additionally be triggered (and preferably are also triggered) by the occurrence of particular, preferably selected (and preferably predetermined) events (that are, e.g., internal and/or external to the hands-free device), and without, e.g., the need for a user action. Such prompts could, e.g., relate to “hands-free device” events, such as being given in response to an internal monitoring process detecting a certain state or condition (e.g. battery level) (e.g. to provide a “warning” prompt in response to detection of the relevant state or condition). Other such prompts could relate to “external” events, such as communications device or network events. For example, a prompt could be provided when an incoming call is received to advise the user of that event, and/or if the communications device is disconnected.

Thus, in a preferred embodiment, spoken prompts may be and preferably are provided (automatically) in response to particular, preferably predetermined events. Most preferably, prompts are provided in response to (selected) user actions, and in response to the occurrence of particular, preferably predetermined events.

In a particularly preferred embodiment, spoken prompts relating to one or more of status reports, the completion of a process (such as, e.g., hands-free device pairing, or call dialling, etc.), and/or “warning” messages (such as, e.g. when an incoming call is received, or the battery is low, etc.), can be and preferably are provided.

In a preferred embodiment, spoken prompts that do not specifically relate to the functions or status, etc., of the hands-free device, etc., can also or instead be given. Such prompts could, for example, be application related and/or relate to user information or data that is broadcast to the communications device. For example, information that is provided to the communications device in the form of text, such as “text messages” (e.g. SMS messages), or other information provided in the form of text (such as song titles, where, e.g., the communications device can play music), could be and preferably can be and is broadcast as spoken prompts via the hands-free device.

This could be done, for example, using an application of the system (e.g. communications device) that has the facility to perform “text to speech” synthesis (such as, e.g., an embedded application that has this function).

The prompts preferably comprise a limited number of words (e.g. 2 or 3) and most preferably comprise a single word, as this is less distracting and easier for a user to remember. Preferably only a limited number of prompts, e.g., less than five, are given at any one time. Most preferably only a single prompt is given at any one time.

The spoken prompts preferably can be (and indeed preferably are) given automatically, and preferably in an unsolicited manner (i.e. such that the prompts are provided automatically and spontaneously (e.g., when a particular prompt “triggering” condition or criteria is met, rather than, e.g., needing a request by a user to trigger the giving of the prompt). However, it would also, e.g., be possible to provide a spoken prompt additionally or solely after a user has activated this function of the hands free device.

The spoken prompts can be provided to a user as desired. For example, where the prompt relates to a status factor or condition of the hands-free or communications device, etc., then the prompt could be given intermittently, for example in response to particular events, such as the particular status factor crossing a given threshold value. Alternatively or additionally, a list of possible functions provided by the hands-free device could, e.g., simply be repeated at periodic intervals while the hands-free device is in use.

In a particularly preferred embodiment, spoken prompts are provided in response to user operation of an input of the hands-free device. Thus, for example, when a user activates an input (e.g. presses a button) of the hands-free device, a spoken prompt relating to the functionality of that input is preferably provided.

Thus, in a particularly preferred embodiment, the hands-free device includes means for, or performs a step of, detecting operation of a user-operable input means of the hands-free device, and providing in response thereto a spoken prompt to the user.

Thus, according to a third aspect of the present invention, there is provided a hands-free device for a communications device, comprising:

means for detecting operation of a user-operable input means of the hands-free device; and

means for providing in response to such detection a spoken prompt to a user of the hands-free device.

According to a fourth aspect of the present invention, there is provided a method of operating a hands-free device for a communications device, comprising:

the hands-free device detecting operation of a user-operable input means of the hands-free device; and

providing in response to such detection a spoken prompt to a user of the hands-free device.

As will be appreciated by those skilled in the art, these aspects of the invention may include any one or more or all of the preferred and optional features of the invention described herein. Thus, for example, the spoken prompt provided in response to detection of user operation of the input means is preferably a prompt that relates to the functionality that the input in question provides. Thus, for example, the hands-free device preferably includes means for or provides a step of, providing, in response to detection of operation of the user-operable input means, a spoken prompt relating to a function or functions operable via the user-operable input means of the hands-free device.

In these aspects and embodiments of the invention, user operation of the input means for triggering the provision of a spoken prompt can be detected in any suitable and desired manner. Thus, for example, a prompt could only be provided in response to the user actually activating the input means. Alternatively, for example in the case of a rotary or sliding switch or dial, any motion of the input means could trigger a spoken prompt, irrespective of whether the input means was properly activated or not.

In a preferred arrangement of these aspects and embodiments of the invention, the spoken prompt that is provided relates solely to the function that can currently be activated by the user input in question (i.e. that triggered the prompt). Thus, in one preferred embodiment only a single prompt, relating to a single function, is given at any one time (and, e.g., in response to a given user-activation of an input or control of the hands-free device).

However, it would also be possible for the spoken prompt to relate to more than one function. For example, where an input can activate plural functions (such as, e.g., might be the case for a rotary dial or sliding switch), the spoken prompt could, e.g., and preferably does, list all the functions that can be activated by that input. This could be done, e.g., when the input is first operated by a user, but not once a user is actively using that input. In such an arrangement, it is again preferred that the spoken prompt is limited in duration, even where it is listing plural functions. Thus, for example, the prompt preferably lists two or more but no more than five functions at any one time.

In a particularly preferred embodiment, the user-operable input means and spoken prompts are arranged such that a first operation of the input means triggers a spoken prompt, and a second operation or activation of the input means (which may be the same as, or different to, the first activation) is then needed to activate the relevant function. Thus, for example, in the case of a rotary dial or switch, rotation of the dial to a particular position or in a particular direction preferably triggers a spoken prompt, and then a further operation of the dial, such as further rotation of it, or, preferably, pressing the dial, activates the function in question. In the case of a push-button input, a first push of the button preferably triggers the spoken prompt, and a second push (preferably, e.g., within a predetermined time period thereafter) activates the function in question.

Thus, according to a fifth aspect of the present invention, there is provided a hands-free device for a communications device, comprising:

means for detecting operation of a user-operable input means of the hands-free device;

means for providing in response to such detection a spoken prompt to a user of the hands-free device;

means for detecting a subsequent operation of the user-operable input means of the hands-free device; and

means for activating in response to such detection of a subsequent operation of the user-operable input means a function provided by the user-operable input means.

According to a sixth aspect of the present invention, there is provided a method of operating a hands-free device for a communications device, the method comprising:

the hands-free device for detecting operation of a user-operable input means of the hands-free device;

providing in response to such detection a spoken prompt to a user of the hands-free device;

detecting a subsequent operation of the user-operable input means of the hands-free device; and

activating in response to such detection of a subsequent operation of the user-operable input means a function provided by the user-operable input means.

As will be appreciated by those skilled in the art, these aspects of the invention may again include any one or more or all of the preferred and optional features of the invention described herein. Thus, for example, the spoken prompt provided in response to detection of user operation of the input means preferably is a prompt that relates to the functionality that the input in question provides.

The user-operable input means for the hands-free device can take any suitable form. Thus they could, e.g., comprise push buttons, rotary switches or dials, or sliding switches, etc., as is known in the art. In a preferred embodiment, the user-operable input means comprises a multi-function button having plural positions, such as a button that has two positions (e.g. “up” and “down”) and that can be pushed. There may be (and, indeed, typically will be) more than one user-operable input means.

Where the hands-free device includes more than one user-operable input means, then spoken prompts can preferably be provided in response to activation of each of the user-operable input means. However, this is not essential, and, e.g., spoken prompts may only be provided for one or a selected number of the user-operable input means, with there being different or no feedback provided in relation to the other user-operable input means.

As well as the spoken prompts provided in accordance with the present invention, it would also be possible for the hands-free device to provide other forms of feedback, such as vibrations, audio tones or beeps and/or to include visual indicators such as LEDs for providing visual feedback to a user. Thus, in a preferred embodiment, the hands-free device can provide and includes means for providing, other forms or modes of feedback. For example, it may be desirable to provide visual feedback, e.g., via an LED arrangement, of the status or progress of charging a battery for the hands-free device. The various modes of feedback, including the spoken prompts, could be, e.g., provided singly and/or independently of each other, or a combination or combinations of some or all of the available forms of feedback could be used, e.g., depending on the circumstances, as desired.

In a preferred embodiment, a predetermined set or sets of spoken prompts is prepared and, e.g., stored for use. The spoken prompts may, e.g., be stored in association with the relevant criteria for providing them, so that they can be selected and provided appropriately in use. The spoken prompts and, e.g., the criteria for selecting them in use, may, e.g., be stored in a memory of the hands-free device itself (and, indeed, in a preferred embodiment the hands-free device includes a memory for this purpose). Alternatively or additionally, they could be stored elsewhere, such as on the communications device, or even on the communications network, and simply provided to the hands-free device as and when they are needed in use. In the latter case, for example, the hands-free device could detect the user activation of an input, and send data indicating this to a server of the communications system (via the communications device to which the hands-free device is coupled), with the communications system server then returning the spoken prompt to be provided to the user in the same way.

Thus, in a particularly preferred embodiment, the hands-free device of the present invention stores and includes a means for storing a set or sets of spoken prompts that may be broadcast in use (in accordance with the present invention).

In a particularly preferred embodiment, the set or sets of spoken prompts to be used, and, e.g., the criteria to be used to select the prompts, can be changed and reconfigured in use. This would allow, e.g., the set of prompts to be tailored, e.g., for specific applications, or, e.g., for the language of the prompts to be changed in use (thereby, e.g., avoiding having to store multiple different language versions of the prompts in the first place). Such changing and configuring of the prompts, etc., can preferably be performed by reprogramming the hands-free device, and/or communications device, etc. The hands-free device is accordingly preferably provided with an input port, such as a USB port, and/or the device another wired or wireless connection, via which it can be reconfigured and reprogrammed for this purpose.

In a preferred embodiment, the hands-free device and/or communications device can alternatively or additionally be reconfigured and reprogrammed for this purpose via software running on a personal computer, or on a personal digital assistant or the like. In a particularly preferred such embodiment, the software comprises, e.g., a graphical user interface running on the personal computer, or on the personal digital assistant, which provides the user with an interface that is capable of guiding the user through the reprogramming and reconfiguring steps. In a preferred embodiment, a or the graphical user interface can alternatively or additionally be provided on the communications device and/or the hands-free device.

Where the spoken prompt or prompts provided to the user can be determined, changed or reconfigured by the user as discussed above, then in a particularly preferred embodiment, the user can record customised prompts, for example voice tags comprising recordings of their own spoken prompts. In a particularly preferred embodiment, the user can program or configure the hands-free device and/or the communications device such that the customised prompts or voice tags are associated with one or more of the existing functions, commands, or the like of the hands-free device and/or the communications device. In this manner, the user can customise the prompts provided to them, when the hands-free device is operated in the manner discussed in relation to any of the embodiments of the present invention disclosed herein, thereby providing particularly meaningful and helpful prompts to the user.

In a particularly preferred such embodiment, the user can program or configure the hands-free device and/or the communications device with customised prompts or voice tags by recording spoken prompts using the graphical user interface discussed above on a personal computer, personal digital assistant or the like, and the recorded prompts can be used to supplement and/or to replace existing prompts stored on the hands-free device and/or on the communications device. Alternatively or additionally, in a preferred embodiment, the prompts provided to the user can be programmed or configured by the user directly via the hands-free device and/or the communications device, for example by using, e.g., the microphone of the hands-free device and/or of the communications device.

In an alternative or additional preferred embodiment, the user can further program or configure the hands-free device, and in particular the menu structures, commands and functions by transferring menu structures and/or commands and/or functions from another device to the hands-free device and/or to the communications device. For example, a PC, PDA or the like having thereon a graphical user interface can be used to transfer menu structures, commands and functions that are stored on the PC, PDA or the like to the hands-free device and/or the communications device. Additionally or alternatively, menu structures, commands and functions can be sent to the hands-free device and/or to the communications device from another source, such as, for example, by transmission directly from a service provider. In these embodiments the menu structures, commands and functions can be transferred to the device in a working format, or can be transferred as an executable program to be run on the device.

In an alternative or an additional preferred embodiment, the spoken prompts can be used as commands for a voice recognition system, for example, to guide a user directly to a desired option, rather than requiring the user to scroll through menus to reach the desired option. For example, the user could speak commands which would be recognised by a voice recognition system and associated with a function or functions of the hands-free device to guide the user directly to that function or functions of the hands-free device.

It will be appreciated that the hands-free device will require the appropriate audio functionality to allow it to provide the spoken prompts to a user, such as a speaker or earpiece (which will already typically be present), an audio codec (if necessary), etc. These functions could be provided by, e.g., an existing processor of the hands-free device, or, e.g., a dedicated digital signal processor (DSP) could be provided for this purpose.

The functions provided by the hands-free device, and that, e.g., spoken prompts may be provided in relation to in accordance with the present invention, may be selected and arranged as desired. They may, e.g., (and indeed, preferably do) comprise any one or more or all of the functions already known or provided by or for hands-free devices, such as, for example, one or more of a power control (on/off switch), a volume control, a control or controls for accepting, rejecting and/or ending a call, a control or controls for carrying out call holding functions, a control or controls for transferring the audio for a call between the hands-free device and the communications device (and vice-versa), a control or controls to activate automatic call pick up and/or voice dialling, etc., a control to mute the microphone of the hands-free device, a control to disconnect the hands-free device from the communications device, a control to check the battery level of the hands-free device, and/or a control or controls for ring tone functions (such as selecting a ring tone), etc.

The various functions provided by or operable via the hands-free device can be arranged and controlled in any suitable and desired manner, such as using arrangements already known in the art. Thus, for example, plural dedicated user-operable inputs could be provided that each has a single function or task, and/or a single, or one or more, multi-function input(s), such as a rotary or sliding switch(es) or dial(s) could be provided.

The Applicants have recognised that particularly where spoken prompts, as in the present invention, are to be provided to a user, it may be desirable to arrange the functions and operations of the hands-free device in a manner that facilitates the provision of and understanding of spoken prompts to and by a user.

Thus, in a particularly preferred embodiment, the functions of the hands-free device are arranged in a menu structure that can be navigated through using input or inputs of the hands-free device to activate functions of the hands-free device. Most preferably sets of functions or commands are grouped together such that a limited number of selected, preferably predetermined, functions can be navigated through at any one time, with the sets of functions being arranged such that a user can move from one set of functions to another, preferably related, set of functions by appropriate activation of an input of the hands-free device. This arrangement effectively means that the function menu structure will comprise multiple layers (each layer comprising one set or group of functions), with each layer containing one or more functions or control options, with a user being able to navigate along a layer or up or down the layers of the function menu structure by appropriate activation of an input or inputs of the hands-free device.

In this arrangement, the function menu structure is preferably arranged such that when a user selects a command or function in a given set of functions (layer), they then move down the menu structure to a new set of functions (layer) that includes functions associated with or relevant to the selected function or command, and so on, until an end function or command, e.g., that activates an operation of the hands-free device is reached. Thus, in effect, in each function set (layer), a given command or function option will either activate a function or operation of the hands-free device, or move the user to another set (layer) of (related) commands or functions that can be selected from. Thus the function menu structure will have, in effect, a tree-type structure with at each level within the tree structure, a user being able to proceed down (different) branches of the tree by appropriate activation of the input means of the hands-free device.

In a preferred embodiment, a user can also select to return to a previous set of functions (go back up a layer (a branch)) in the function menu structure, e.g., by appropriate activation of the or a user input of the hands-free device. Most preferably a user can also select to return to a base, e.g., default, set of functions (layer) of the menu structure.

The commands or functions that can be activated or selected in any given set of functions (at any given layer) in the menu structure are preferably arranged sequentially, i.e. such that they will be presented to a user one after another as the user activates the input means. They are most preferably arranged as a wheel or endless loop, i.e. such that proceeding beyond the last command or function of the set (layer) returns the user to the first command or function of the set, and vice-versa, so that the user can proceed through the set of commands or functions again. Preferably each set (layer) of commands and functions can be navigated in both directions (i.e. forwards and backwards).

The number of commands or functions in each set (layer) of the menu structure, and the number of sets (layers), can be selected as desired and will depend, e.g., on the function or functions of the hands-free device in question. However, in a preferred embodiment, there are only a limited number (preferably five or less) of commands or functions included in each set (accessible in each layer), as this facilitates the provision and understanding of spoken prompts relating to the commands and functions to a user.

Where the functions of the hands-free device are arranged in a menu structure as described above, then a spoken prompt relating to each command or function is preferably provided as and when the user navigates to the respective command or function in the menu structure. Thus, for example, as a user navigates through one set of function options (along a layer of the menu structure), the commands or functions selectable in that set (via that layer) will be successively spoken to the user. Thus, in effect, the user can cycle through a range of command or function options, each of which options is presented by voice to the user in real-time as it is reached.

It can be seen from the above that, accordingly, in a particularly preferred embodiment of the present invention, the functions provided by the hands-free device will be arranged in multiple sets (layers) of selectable functions, with each set (layer) having a loop of functions that can be selected, and one or more of the functions in at least some of the sets (layers) moving the user into another function set (layer) having another loop of functions that can be selected from, and so on.

Such a “cyclic” and “nested” or layered arrangement of the functions provided by a hands-free device is believed to be particularly suitable for use with spoken prompts relating to functions or commands of the hands-free device, since a user will, in effect, at each stage hear a wheel of prompts giving the options that they may currently select from. This is believed to be an easier concept for a user to understand and operate based solely on spoken information that they are provided with.

Alternatively or additionally, in a preferred embodiment, other indicators of the available options can be, and preferably are, provided, such as music or other sounds. For example, with menu structures having multiple layers of functions, background sounds or music could be constantly played to a user, with different sounds or music provided to indicate which layer of the structure the user is in, or which set of functions are presently available.

It is believed that such a menu structure for user operable commands and functions of an electronic device may be new and advantageous in its own right, and not just in the context of hands-free devices for communications devices, particularly where the menu of user operable commands and functions is to be presented audibly to a user.

Thus, according to a seventh aspect of the present invention, there is provided a method of providing a user interface for an electronic device, comprising:

arranging user-selectable commands and functions of the device in a menu-structure through which a user may navigate to select a desired command or function of the device using user-operable input means of the device;

wherein, in the menu-structure, sets of commands or functions of the device are arranged as endless loops around which a user may navigate, and the arrangement is such that a user may navigate between such sets of commands or functions using user-operable input means of the device.

According to an eighth aspect of the present invention, there is provided an apparatus for providing a user interface for an electronic device, comprising:

means for arranging user-selectable commands and functions of the device in a menu-structure; and

user-operable input means via which a user may navigate through the menu-structure to select a desired command or function of the device;

wherein, in the menu-structure, sets of commands or functions of the device are arranged as endless loops around which a user may navigate using the user-operable input means of the device, and the arrangement is such that a user may navigate between such sets of commands or functions using the user-operable input means of the device.

Again, these aspects and embodiments of the invention may include any one or more or all of the preferred and optional features of the invention discussed herein, as appropriate. Thus, for example, spoken prompts are preferably provided as options or functions are encountered in the menu structure, and, indeed, the menu structure preferably relates to commands and functions of the device that are presented to a user in audio manner, and most preferably that are only presented in an audio manner.

Where such a menu-structure for functions and operations of the hands-free device is used, then the user-operable input means for navigating the menu structure is preferably arranged appropriately. Thus, in a preferred embodiment, a rotating dial or switch is provided for navigating through the menu structure, which can, e.g., be rotated in either direction to go around the loop of a set of functions (a layer) of the menu structure, and, e.g., be pressed to select one of the options provided by the set (layer) (and then, e.g., move to another set (layer) of the menu structure).

However, it would also be possible to provide such navigating functionality with other forms of input, such as a slider, a slide switch button, or a set of buttons (e.g. having operations that move “forward” through a set of functions, move “back” to a previous set of functions, and “select” the current function, respectively) if desired. It would also be possible, where the hands-free device has an appropriate speech-command enabled user interface to additionally or alternatively provide voice-activated navigation of the function menus and sets (e.g. via spoken “advance”, “back”, and “select” commands).

In a particularly preferred embodiment, the user-operable input means can provide a function of moving successively through a set (layer) of menu functions (selections) (this is preferably provided by means of rotating or sliding a button or dial), a function of selecting an option in the menu (to, e.g., enter another set (e.g. submenu) of functions or to execute a function) (this is preferably activated by a single button push), a function of going back one step (level)) in the menu structure (i.e. to return to a previous set of functions) (this is preferably activated by making a double button press (e.g. pressing the same button twice in a particular, e.g. predetermined, time period), and a function of returning to an initial or default set of functions (e.g. the “main” menu of the menu structure (this is preferably activated by a long button press (e.g. pressing a button continually for a particular, e.g. predetermined, time period).

As well as, as discussed above, providing a spoken prompt as and when a selectable function or option is encountered in the menu structure, it would also be possible to provide other forms of feedback regarding the menu navigating process. For example, in a preferred embodiment progressive audio tones are provided for each option in a given set (layer) of functions in the menu structure, and/or transition audio tones are provided as a user navigates between sets of functions. It is also preferred to provide higher octave (audio frequency) tones as a user navigates further down the menu structure.

In a preferred embodiment, the function menu structure is arranged such that two or more sets of function menus are provided, that are to be used, e.g., depending on the current status or circumstances of the hands-free device. For example, one function menu is preferably provided for use when the hands-free device is in a standby or idle mode, with a separate, independent function menu being provided for use when the hands-free device is “active” or in an “active” mode, e.g., for use when an incoming call is received, and/or for use during a call.

In a particularly preferred embodiment, the spoken prompts are or can be broadcast to a user in such a way that they appear to have a spatial position or orientation relative to the user and/or hands-free device. For example, a prompt could appear to be being spoken (to come from) the left or right of the user, and/or to be closer to or further from the user, etc. Thus, in a preferred embodiment, the spoken prompts can be provided in such a way that they can appear to the user to come from one or other side (e.g. to his or her left or right) and/or appear to come from closer to or further from a user.

Such “spatial” orientation of the spoken prompts is believed to again assist a user in understanding and remembering the prompts and, e.g., the functions to which they relate. It is believed that such arrangements will be particularly advantageous in the case of spoken prompts relating to function menus of the hands-free device, particular where the functions are arranged cyclically, as discussed above. For example, the prompts for different functions selectable by the user could be arranged to come from different directions in space, so as to, e.g., help the user to visualise the available set of functions.

Such arrangements for the prompts can be achieved in any suitable and desired manner. For example, where the hands-free device provides stereo sound, the “spatial” position of the prompt could be varied by adjusting the audio left and right ear parameters, as is known in the art.

Similarly, the volume of the prompts could be varied to give the impression of them being closer to or further from the user. Indeed, in a preferred embodiment, the volume that the prompts are broadcast can be (and preferably is) varied (preferably automatically) as between prompts (whether for this or other reasons), e.g., such that successive spoken prompts will be broadcast at different volume levels. (It should be noted here that such different volume broadcasting of the prompts would be irrespective of any volume setting for the prompts set by a user, and should also be contrasted with the user adjusting the volume setting between prompts: the change in volume is carried out independently of and irrespective of any user adjustment of the prompt volume).

It is believed that providing audible prompts that also appear as though they have a spatial orientation relative to a user may be new and advantageous in its own right, and not just, e.g., in the context of a hands-free device for a communications device.

Thus, according to a ninth aspect of the present invention, there is provided a method of providing a user interface for an electronic device, comprising:

providing spoken prompts to a user of the device in such a way that different spoken prompts appear to come from different positions relative to the device.

According to a tenth aspect of the present invention, there is provided an apparatus for providing a user interface for an electronic device, comprising:

means for providing to a user of the device spoken prompts that appear to come from different locations relative to the device.

Again, these aspects and embodiments of the invention may include any one or more or all of the preferred and optional features of the invention discussed herein, as appropriate. Thus, for example, the spoken prompt preferably relate to functions of or operable via the device, and are preferably related to options or functions that are encountered in a function menu structure of the device. Similarly, the prompts can preferably at least be given so as to appear to come from the left or right of the device (e.g. such that successive prompts can be made to appear to come from opposite sides of the device), and/or from closer to or further from the device. It is also preferred that the electronic device is a hands-free device for a communications system.

In a particularly preferred embodiment, spoken prompts are not given or can be arranged not to be given for one or more functions (e.g. selected or particular functions) operable via the hands-free device. The Applicants have recognised that in some circumstances, such as when a call is in progress, or an urgent action is needed, a spoken prompt may not be desirable, as it may, e.g., be inappropriate or cause an undesirable delay. Thus, in a preferred embodiment, there are one or more functions operable via the hands-free device for which a spoken prompt will not be provided. Most preferably the arrangement is such that the spoken prompts are selectively provided, e.g. depending on the mode of operation of the hands-free device. In a preferred embodiment, spoken prompts can be selectively disabled for a given function or functions, e.g. automatically, or by a user.

Indeed, particularly where the functions of the hands-free device are arranged in a menu structure as described above, it is preferred for a user to be able to configure and customise the functions of the hands-free device more generally. For example, a user can preferably configure a set of function options, such that the commands or functions selectable in that set, and/or the prompts relating to the commands or functions selectable in that set, can be disabled so that the disabled functions or commands are not presented to the user, and/or so that the related prompts are not spoken to the user. This is particularly useful if, for example, there are default functions or commands which the user never or rarely requires, and therefore which the user does not wish to have presented to them, or in relation to which the user does not want to be prompted.

Furthermore or alternatively, in a preferred embodiment, the hands-free device or communications device can be configured by the user such that functions that are not provided in a particular set of functions (e.g. menu structure) by default can be enabled such that they are provided to the user in that menu structure.

For example, if the default setting of a device is that a particular function does not have a spoken prompt associated therewith, the hands-free device and/or the communications device can preferably be reprogrammed or configured such that an existing spoken prompt, and/or a customised prompt as discussed above, is associated with that function. Or, for example, if a function or command is embedded in a different menu structure or if it is not associated with a menu structure by default, then the hands-free device and/or the communications device can preferably be reprogrammed or configured to remove or copy that function or command from the different menu structure into a desired menu structure or to embed the function or command into the desired menu structure.

Thus in preferred embodiments the hands-free device and/or a communications device can be configured by a user to have desired functions and commands arranged in customised menus or structures and with existing or customised spoken prompts associated therewith, and the user can remove, disable or rearrange functions or commands (e.g. that they do not wish to use regularly) e.g. so that spoken prompts are not provided for the functions or commands that they do not require.

Still further, in a preferred embodiment, a user can preferably configure short-cuts to existing functions or commands of the hands-free device and/or of the communications device, to which quick access is required. For example, a short-cut menu function or command can preferably be provided such that when the user selects the short-cut function or command, other menu functions or commands that would otherwise be, for example, scrolled through to reach the desired function or command, are bypassed, and the hands-free device or communications device menu structure instead navigates directly to the desired function or command. In a particularly preferred such embodiment, a short-cut prompt is provided when the short-cut function or command is selected, and preferably the short-cut prompt provides the user with information regarding, for example, the destination of the short-cut.

These arrangements are particularly useful with a hands-free device where the functions of the hands-free device are arranged in multiple sets (layers) of functions, and that may overlap, since the user of the hands-free device can configure the device such that the menus they use most often are compact and easily accessible and such that they can navigate between menu structures using short-cuts and/or customised prompts as desired.

The various functions and components described above and herein that comprise or form part of the present invention, or a device incorporating the present invention, may, as is known in the art, be performed by or provided as discrete, individual components, e.g., in the hands-free device itself. However, as will be appreciated by those skilled in the art, they may also be performed by or provided, as, e.g. different “parts” of the same component (e.g. processing unit) or in a distributed form, on the hands-free device or elsewhere. It would also be possible, as is known in the art, for components or functions of the invention to be distributed across the hands-free device, the communications device to which it is coupled, and, indeed, the communications system network, and, e.g., to be performed in part on the hands-free device itself and, e.g., also on, e.g. the communications device and/or, e.g. a server of, the communications network, etc., to which the communications device connects. For example, the spoken prompts could be stored in and provided by the communications network in use, rather than, e.g., being stored on the hands-free device itself.

As will be appreciated by those skilled in the art, all of the above aspects and embodiments of the invention may include any one or more or all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out the methods hereinabove described when installed on data processing means, and a computer program element comprising computer software code portions for performing the methods hereinabove described when the program element is run on data processing means. The invention also extends to a computer software carrier comprising such software which when used to operate a hands-free device, communications device or network comprising data processing means causes in conjunction with said data processing means said device and/or network to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will now be described by way of example only and with reference to the accompanying drawings, in which:

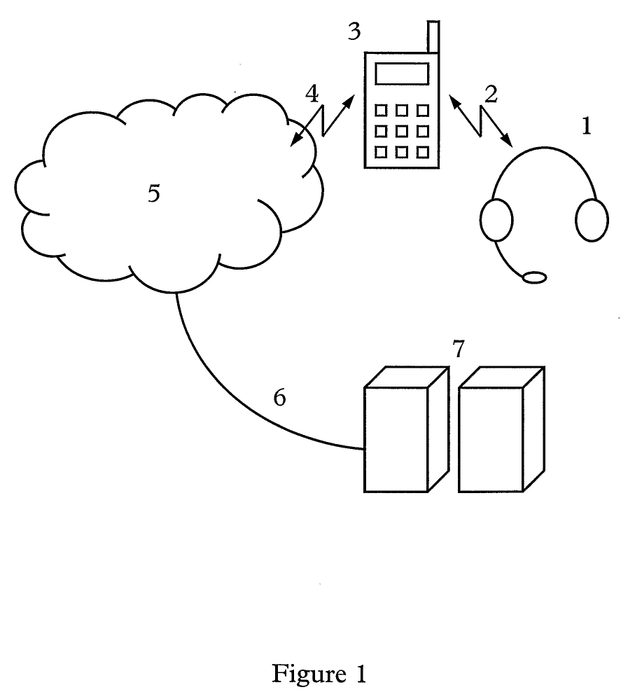

FIG. 1 shows schematically an arrangement of a hands-free device and communications device;

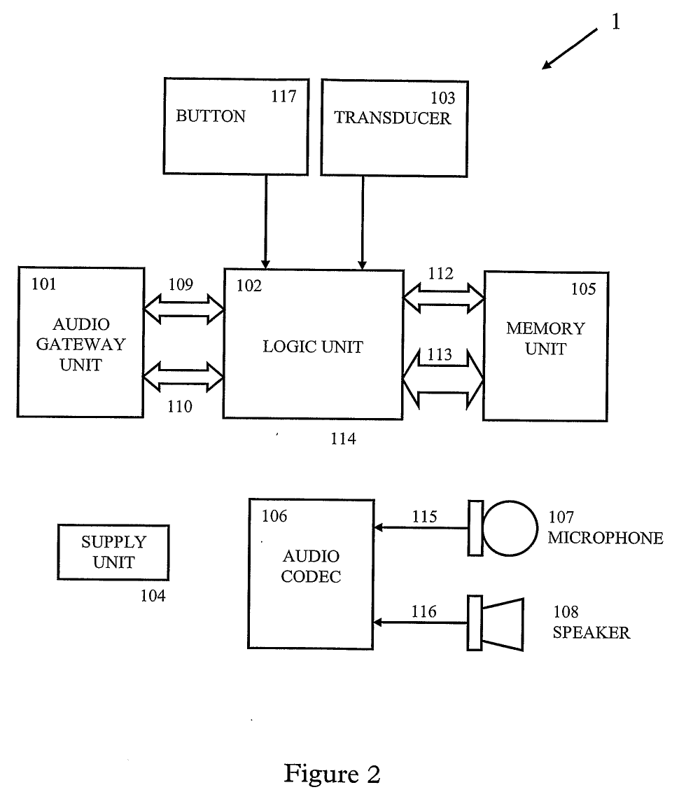

FIG. 2 shows schematically the hands-free device of FIG. 1;

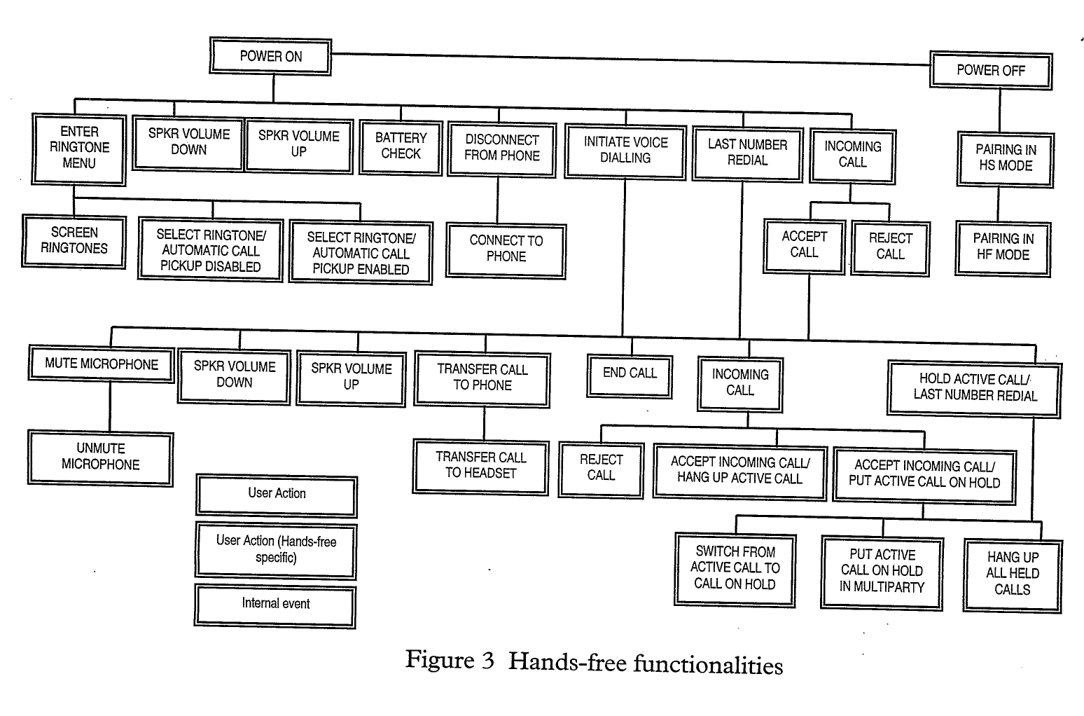

FIG. 3 shows schematically the functions operable via the hands-free device of FIG. 2; and

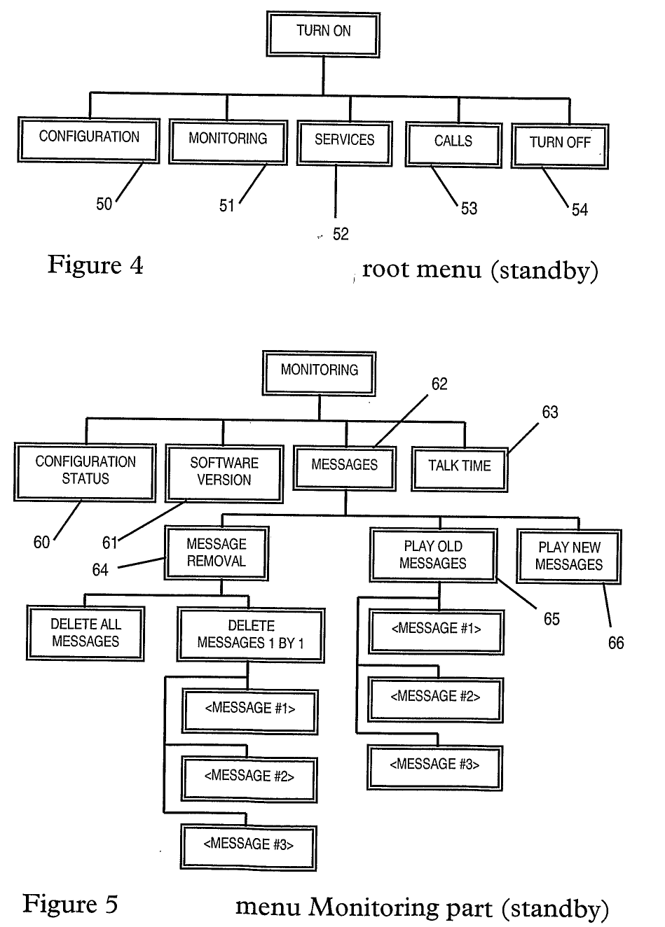

FIGS. 4 to 9 show exemplary function menu structures for the functions operable via the hands-free device.

FIG. 1 shows schematically an arrangement of a hands-free device 1 that is linked via a short range radio frequency (RF) communications link 2 to a mobile communications device 3 in the form of a mobile phone that is in communication via an RF link 4 with a mobile communications network 5. FIG. 1 also shows a server 7 of a mobile network operator or service provider that is connected via a link 6 to, and may be accessed via, the mobile communications network 5.

In FIG. 1, the hands-free device 1 is shown as being in the form of a headset for wearing on the user's head. However, it could, of course, take other forms, such as be a car or vehicle-mounted hands-free kit. Equally, although the communications device 3 has been shown as being a mobile phone, it could be any other form of communications device (whether mobile or otherwise), such as a mobile radio, personal digital assistant, or a vehicle-mounted mobile terminal.

The hands-free device 1 is linked to the mobile communications device 3 by means of a short range RF link 2 that operates according to the Bluetooth protocol. However, other short range RF communications protocols, or indeed, other non-RF, wireless links, such as a magnetic induction link, could be used to couple the hands-free device to the mobile communications device 3 instead. A wired connection between the hands-free device 1 and the mobile communications device 3 would also be possible.

As is known in the art, the link 2 between the hands-free device 1 and the mobile phone 3 acts, inter alia, to redirect all the audio for a call from the mobile phone 3 to the hands-free device 1, such that a user can participate in a call via the hands-free device 1. The hands-free device 1 can also control certain functions of the mobile communications device 3, such as being able to accept or reject an incoming call. It also includes a volume control for its audio playback.

FIG. 2 shows the architecture of the hands-free device 1 in more detail.

As shown in FIG. 2, the hands-free device 1 includes, inter alia, a logic unit 102, a memory unit 105, an audio gateway unit 101, a supply unit 104, an audio codec 106, a microphone 107, a speaker 108, a transducer unit 103, and a user-operable rotary input button 117. In the present embodiment, the audio gateway unit 101, the logic unit 102 and the audio codec 106 are embedded in a single chip circuit. However, other arrangements would, of course, be possible.

The logic unit 102 of the hands-free device 1 controls the hands-free device 1, and executes the functions required to operate it. It also controls communication between the hands-free device 1 and the mobile communication device 3, and acts upon commands input to the hands-free device 1 by a user. In the present embodiment, this logic unit 102 is in the form of a microprocessor or digital signal processor (DSP). (However, other arrangements, such as a micro-controller, an FPGA unit, an application specific integrated circuit (ASIC), or combination of these devices could also be used for the logic unit 102.)

The audio codec unit 106, together with the microphone 107 and speaker 108 provides, as is known in the art, the audio signals and corresponding electrical signals for transmitting and receiving the audio signal for a call to and from the hands-free device 1. Thus, for example, the audio codec unit 106 converts electrical signals 115 coming from the microphone 107 into data 114 that can be processed by the logic unit 102 for onward transmission to the mobile communications device 3. Similarly, the audio codec unit 106 converts data 114 provided by the logic unit 102 into electrical audio signals 116 to be sent to the speaker 108 for audio reproduction. More than one microphone and/or speaker may be provided in the hands-free device 1, if desired.

The memory unit 105 stores all the data required to operate the hands-free device 1 and can be accessed by the logic unit 102 by means of control signals 112 that can be exchanged between the memory unit 105 and the logic unit 102 in order to store or retrieve data 113. The memory unit 105 is non-volatile and electronically writable. In the present embodiment it comprises a flash memory device, but other arrangements, such as a RAM memory or a combination of ROM and RAM or a memory extension such as an external memory stick, would also be possible.

The memory unit 105 of the hands-free device 1 also stores a menu structure for commands and options that may be activated by the user operable input button 117 of the hands-free device 1 (this will be explained further below), together with a set of spoken prompts corresponding to those commands and options. The spoken prompts are stored in the form of suitable audio primitives that may be replayed as spoken words via the audio codec 106. The audio primitives are coded in such a way that they can be replayed substantially in real-time.

In the present embodiment, the logic unit 102 of the hands-free device 1 includes a dedicated digital signal processor (DSP) for implementing the audio processing of the stored audio primitives and for providing them appropriately to the audio codec 106 for broadcasting to a user. This helps to avoid such audio processing disturbing the operation of the, e.g., Bluetooth processor that will be provided as part of the logic unit 102 for coupling the hands-free device 1 to the communications device 3. Other arrangements would, of course, be possible.

It should also be noted here that this audio processing of the audio primitives and spoken prompts is arranged such that it will not interfere with the “normal” operation of the, e.g., Bluetooth link, and such that spoken prompts can be provided whether or not the Bluetooth link is activated. This can be done, e.g., by providing one memory chipset for use by the logic unit 102 for communication and system management operations, etc. (i.e. including the control and operation of the Bluetooth link), and a second, separate memory chipset for the spoken prompt processing, i.e. for use by the DSP that performs the retrieval (and storage) of the voice prompts. Other arrangements would, of course, be possible.

The transducer 103 of the hands-free device 1 provides the user interface or MMI (man-machine interface) that allows the user to control the hands-free device (and thereby the mobile communications device to which it is coupled) to, for example, control the volume of the audio signal provided by the hands-free device 1, initiate or end a call through the mobile communications device, respond to or reject an incoming call, etc. The transducer unit 103 provides logic signals 111 to the logic unit 102 in response to the user inputs, and the logic unit 102 then interprets those signals and controls the hands-free device 1 and the mobile communication device 3 accordingly.

The user interface provided by the transducer 103 includes the user-operable input button 117. In the present embodiment, this user operable input button 117 is in the form of a rotary control (dial) that can be rotated in both a clockwise and anti-clockwise direction, and that can also be pressed inwardly. This input button 117 of the hands-free device 1, once activated, sends to the logic unit 102 a signal 118 that activates the appropriate operation of the hands-free device 1. (It should be noted here that although the input button 117 has been shown as a separate component in FIG. 2, it is in practice part of the overall user interface (MMI) provided by the transducer 103.)

The user interface of the hands-free device 1 also includes, inter alia, a two colour LED display that can provide visual feedback to a user relating to the operational status of the device. (Other more complex visual displays, such as more complex sets of different coloured light emitting diodes, or a liquid crystal display, could also be used and provided, if desired.) This LED display is used to provide visual feedback, inter alia, related to charging of the battery 104 of the hands-free device 1, and to provide a visual indication reflecting certain system states and changes.

The user-interface provided by the transducer 103 could also include other buttons, switches, etc., if desired. It could also, e.g., include or comprise a keypad or keyboard, and/or a speech-enabled interface.

The audio gateway unit 101 of the hands-free device 1 provides the interface and link between the hands-free device 1 and the mobile communications device 3 to which it is coupled. As discussed above, in the present embodiment, the audio gateway unit 101 links the hands-free device 1 and the mobile communications device 3 by means of a short range RF Bluetooth communications link. The audio gateway 101 transmits and receives commands and control signalling 109, and the audio signal 110 for a call, between the hands-free device 1 and the mobile communications device 3.

The power supply unit 104 provides energy to all the active circuits of the hands-free device 1. In the present embodiment this power supply unit 104 comprises a battery (together with any necessary associated circuitry). However other arrangements would be possible, such as a DC/DC converter when the hands-free device is to be powered by a constant current source, or an AC/DC converter for use with an alternating current source.

The hands-free device 1 also includes a data input port (not shown) in the form of a USB port that allows the hands-free device 1 and its operation to be reconfigured and reprogrammed in use. Of course, other data input interfaces, such as a serial interface, could be used if desired. In some embodiments, the hands-free device can be configured via a graphical user interface or other suitable software provided on, for example, a personal digital assistant, laptop or personal computer to which the device is interfaced via the USB or serial connection or the like.

FIG. 3 shows the basic functions that are provided and supported by the hands-free device 1 of the present embodiment. As can be seen from this figure, the functions supported by the hands-free device 1 include user actions and internal events, such as incoming calls.

In the present embodiment, the user operable functions of the hands-free device 1 are arranged in a hierarchical menu structure that a user can navigate through and around and select from using the user operable input means 117 of the hands-free device 1.

In this menu structure, functions of the hands-free device 1 are arranged in groups that a user can navigate around, and selects a function from. Selecting a function from a given group may then either activate the function, or navigate into a sub-group or layer of the menu structure which a user can then again navigate around and select from, and so on. Each group or layer of functions in the menu structure is arranged sequentially as an endless loop, i.e. such that as the user navigates past the last function in the group, the system automatically returns to the first function and so on. In other words, the available functions in each group are arranged in sequential order that a user can continuously and repeatedly loop around. In effect, the user can cycle through a group or set of functions, and then from that group or set of functions navigate to other groups or sets of functions, as desired, until they activate the desired function.

Each function or option that can be selected in the menu structure also has associated with it a spoken prompt that is automatically provided to the user when that function is reached in the menu structure.

FIGS. 4 to 9 show the menu structure of the present embodiment that is provided for carrying out the functions shown in FIG. 3.

FIG. 4 shows the initial, standby root menu that is activated when the hands-free device is first activated or in standby mode. In this situation, a user can select from five different menu options, namely a configuration mode 50, a monitoring mode 51, an operator services mode 52, a call mode 53, and to turn-off the hands-free device 54. The operator services mode 52 is provided to allow for the inclusion of operator services, such as the provision of specific information on certain areas of interest, directly via the hands-free device 1.

In this function menu, as the user rotates the user operable input means 117 of the hands-free device 1, that input will step between each of the possible functions shown in FIG. 4 in turn, and as each function is reached, will speak or provide a spoken prompt describing the function that has been reached. In the present embodiment, the spoken prompt that is given corresponds to the text shown (i.e. the name of the function shown) in FIG. 4 (and correspondingly in the remaining FIGS. 5 to 9 showing the menu structure).

When the user has navigated to one of the functions shown in FIG. 4, and heard the corresponding spoken prompt, they can then select that function by pressing the user operable input means 117 of the hands-free device. In the case of the turn-off option 54, for example, when the user reaches that option, they will hear the spoken prompt “turn off” and then be able to select that function (which selection will simply turn off the hands-free device 1). In the case of the other options, activating those options will drive the hands-free device into a further sub-menu structure of the hands-free device function structure that relates to the particular selected mode.

For example, if the user selects the “monitoring” option 51 in FIG. 4, that moves the hands-free device into a “monitoring” sub-menu, which is shown in FIG. 5. In this menu, the user is first presented with a navigable set of options comprising “configuration status” 60, “software version” 61, “messages” 62 and “talk time” 63. The user can accordingly select one of these functions as before. In this case, selecting the “messages” 62 option, for example, will then move to a further sub-menu relating to messages, which contains the functions “message removal” 64, “play all messages” 65, or “play new messages” 66. Selecting message removal 64 or play all messages 65 further drives the system into additional function menus, as shown in FIG. 5.

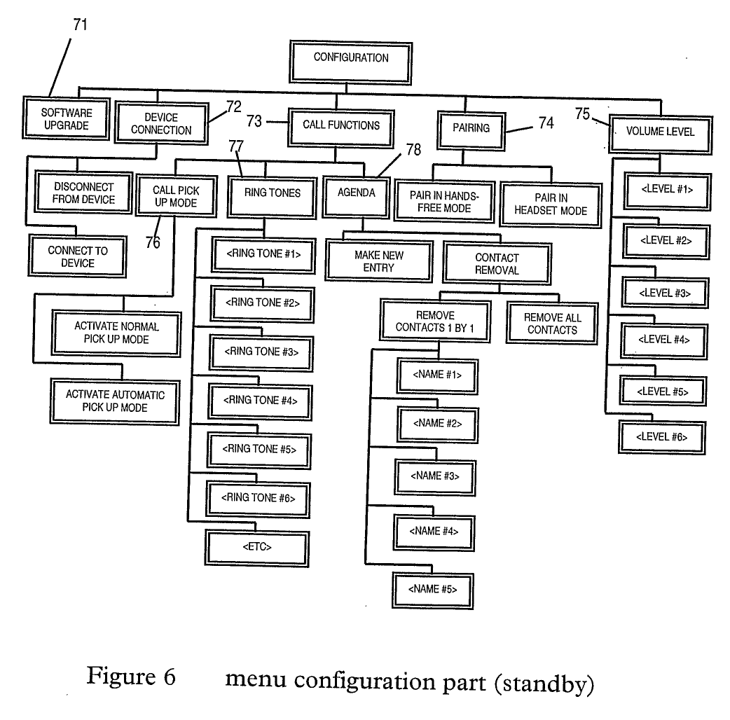

FIG. 6 shows the corresponding sub-menu structure for the configuration mode 50 of FIG. 4. In this mode, the user is first provided with options relating to “software upgrade” 71, “device connection” 72, “call function” 73, “pairing” 74 or “volume level” 75. Again, a user can select one of these functions and thereby navigate to a further sub-menu relating to the selected functions. Thus, for example, in the case of a call function 73, selecting that function then moves to a menu relating to “call pickup mode” 76, “ring tones” 77, or “agenda” 78. (“Agenda” 78 relates to the ability to provide a “voice agenda” in the hands-free device to allow a user to, e.g., call particular numbers or contacts simply by speaking a voice “tag” that has been associated with the respective number, as is known in the art.)

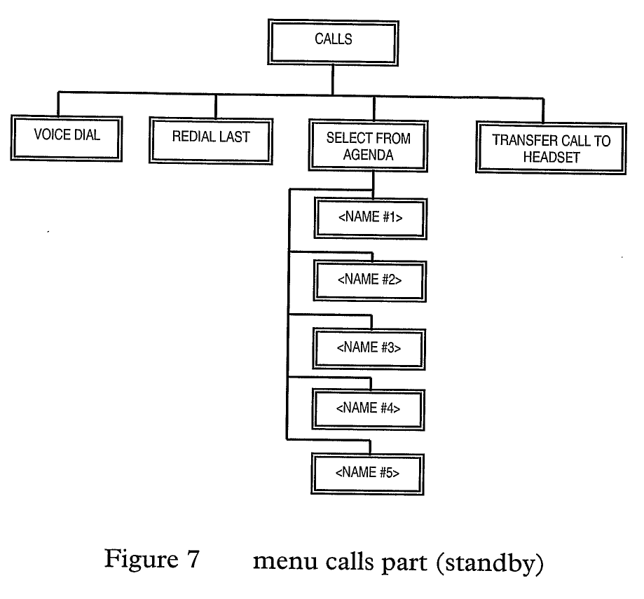

FIG. 7 shows the corresponding menu structure and functions that can be accessed via the calls mode 55 shown in FIG. 4.

As well as the above commands and functions that can be activated during the standby mode of the hands-free device, the present embodiment also provides a number of functions that can be activated in response to events, such as when an incoming call is received. These command and function options are again arranged in menu structures and have corresponding spoken prompts associated with them.

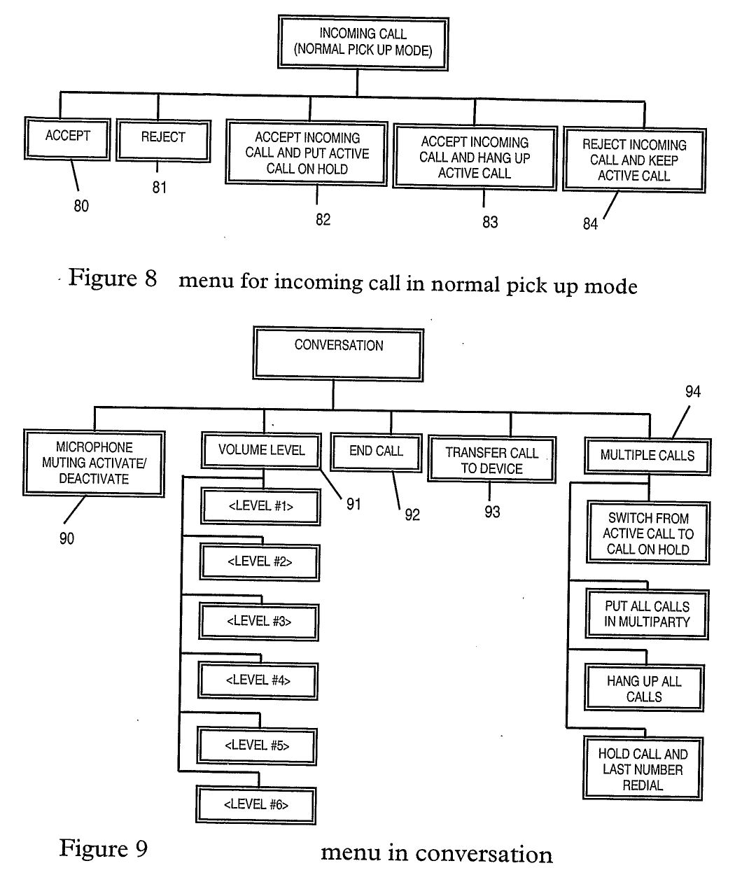

FIG. 8 shows the menu structure of the commands and options available when an incoming call is received in normal pickup mode. In this case, the user can cycle between and select the options of “accept the call” 80, “reject the call” 81, “accept an incoming call and put an active call on hold” 82, “accept an incoming call and hang up an active call” 83, and “reject an incoming call and keep the currently active call” 84.

FIG. 9 shows the menu structure for commands and options that are available during a conversation that is being relayed via the hands-free device 1. In this case, the user can initially select between options of “activate or deactivate microphone muting” 90, adjusting the “volume level” for the call 91, “end call” 92, “transfer call” to the mobile communications device to which the hands-free device is coupled 93, or handle “multiple calls” 94. Again, activating some of these functions will step down to sub-menus of the function menu structure.

As will be appreciated by those skilled in the art, the order of the functions and the functions themselves shown in the menu structures described above can, of course, be varied from that described in the present embodiment, as desired. Additionally or alternatively, it will be appreciated that one or more of the functions can be disabled by the user, for example by reconfiguring and reprogramming the hands-free device via, for example, a graphical user interface of a personal digital assistant, laptop or personal computer or the like connected to the hands-free device. Furthermore, any functions of the hands-free device that are not present in a menu structure can be enabled, rearranged or inserted into the appropriate menu structure by the user as desired. Furthermore, short-cuts can be created by the user to provide more direct access to desired functions, for example.

In addition to the above discussed spoken prompt relating to the function menu structure of the hands-free device 1, the hands-free device of the present embodiment can also provide spoken feedback relating to the current state of charge of the battery 104 of the hands-free device. In order to do this, the hands-free device periodically monitors its battery level during use (at intervals of between 1 and 10 minutes), compares the determined battery level with one or more predetermined threshold battery charge levels, and provides an appropriate spoken prompt indicating the current level of charge of the battery whenever a battery charge level threshold has been crossed.

As discussed above, the rotary dial user-operable input means 117 of the hands-free device 1 is used in the present embodiment to navigate through the function menus of the hands-free device 1, and to select options and functions from those menus.

To this end, the rotary dial user input 117 is arranged so that rotation of the dial in either direction will step successively through the current set of functions provided by the menu (in the direction appropriate to the direction of rotation of the dial), i.e. such that as the dial is rotated, the user will successively step to, and be presented with a spoken prompt for, each function or option that is selectable in the current set of functions being navigated. A single press of the rotary dial input 117 is then used to select the current option, i.e. either to enter a further set of options (submenu of the function menu structure), or to execute the appropriate command or function.

The rotary dial input 117 is also arranged such that a double push of the dial (i.e. the user pressing the dial twice in succession within a predetermined time period) will cause the system to return to the previous set of functions that were being navigated (i.e. to go back up one level in the function menu structure). Finally, a long button press of the rotary dial input 117 (i.e. pressing that dial continuously for a predetermined time period) can be used to return the system to the initial set of functions for the function menu in question (i.e. to return the system to a default main menu).

Other arrangements for the user input and menu navigation would, of course, be possible. For example, a sliding switch arrangement could be used instead of a rotary button. It would also be possible to, e.g., use a multi-function button with three positions, representing “advance”, “back” and “select”. For example, the switch could be moved between two alternative positions representing “advance” and “back”, and, e.g., pressed to “select” the option in question. Alternatively, a set of buttons having dedicated functions (such as “advance”, “back” and “select”) for navigating through the function menus available on the hands-free device could be provided. It would also, e.g., be possible in an appropriately speech-enabled hands-free device to allow a user to use speech commands to navigate through and select the commands and options that are available, for example by using a set of spoken commands such as “advance”, “select” and “back”.

As well as the spoken prompts that are provided as a user navigates to each selectable function and option in the menu structure as discussed above, in the present embodiment further audio tones and prompts are provided to assist the navigation process. In particular, progressive audio tones are provided as each successive option is reached in a given set of options (i.e. layer or level of the menu structure). Furthermore, a higher octave audio frequency is used for these tones for sets of functions that are lower in the menu structure (i.e. as the user progresses down the levels of functions in the menu structure). Finally, a transition tone or tones is also provided whenever a user navigates between sets of functions (i.e. levels in the menu structure).

As well as the above menu structure that can be navigated using the user-operable input 117 and for which spoken prompts are provided to a user, in the present embodiment there are also a number of functions that can be executed directly and without the provision of spoken feedback to the user. This is so as to avoid, for example, a spoken prompt being undesirably broadcast during, e.g., a conversation, and/or the need to provide spoken prompts and navigate through the function menu leading to undesirable delays in activating a function. In the present embodiment the functions that can be directly activated comprise accepting an incoming call, muting or unmuting the microphone of the hands-free device 1, increasing or decreasing the speaker volume of the hands-free device 1, and ending a call. A separate volume control, call accept or reject button, and mute and unmute microphone button are provided to activate these functions, which buttons do not have associated with them spoken prompts relating to their functions.

As well as the user operable input 117 for navigating through and selecting the command and function menus of the hands-free device, it would also, of course, be possible to provide on the hands-free device further user operable inputs, such as buttons, etc., for implementing additional or alternative features of the hands-free device. Indeed, as discussed above, a separate volume control, and call accept or reject button, are preferably provided on the hands-free device 1.

In the present embodiment, the hands-free device 1 can have its menu structure and spoken prompt arrangement reconfigured in use by reprogramming it via the data input, USB, port of the hands-free device 1. This would allow, for example, the functionality of the hands-free device and the spoken prompts to be tailored to particular users and/or e.g., communications system operators or providers. It would also facilitate, e.g., storing spoken prompts in different languages, without, e.g., the need to store prompts in plural different languages in the hands-free device 1 simultaneously. It would also facilitate, e.g., otherwise upgrading of the hands-free device 1. It would also facilitate, e.g., creating customised or personalised spoken prompts. For example, a user could record their own prompts and associate the spoken prompts with an existing function or functions of the hands-free device. Configuration of the hands-free device could, e.g. be carried out via, for example, a graphical user interface running on an external device such as a personal digital assistant, laptop or personal computer connected to the hands-free device.

In the present embodiment, the complete function menu structure and system, together with the spoken prompts, is stored (embedded) in the hands-free device 1. However, this is not essential, and it would also, e.g., be possible for aspects or functions of this operation to be implemented and supported elsewhere, but, e.g., appropriately accessible via the hands-free device 1 in use. Thus, for example, in one alternative arrangement, the function menu structure, spoken prompts, etc., could be stored and provided on a server of a mobile communications network to which the hands-free device 1 is coupled, and in that case, the hands-free device 1 could, e.g., detect user operation of the user operable input means 117 on the hands-free device, and construct and send a message (e.g. via a data network, such as GPRS) to that effect to the mobile communications system, with a server of the communications system then returning an appropriate spoken prompt in the same way, which prompt could then be decoded in the hands-free device 1 to provide the spoken prompt to the user.

It can be seen from the above that the present invention, in its preferred embodiments at least, provides an improved user interface and user controllable functionality in a hands-free device for a communications device.

This is achieved, in the preferred embodiments of the present invention at least, by providing spoken feedback to a user in real-time, so that he or she can understand the options and commands available and that can be and have been selected using an input of the hands-free device. In particular, an audio voice interface is provided between the hands-free device and the user, that allows a user to hear in real-time the options he or she is going through when commanding the hands-free device.

Furthermore, the various user selectable functions and options that are available are arranged in a menu structure through which a user can navigate using an input of the hands-free device to access the hands-free device's functionality and operations. This menu structure is arranged such that sets of options arranged as a wheel or endless loop around which a user can navigate are presented to the user, with the selection of a specific option in a wheel then, e.g., driving the user to another wheel of sub-options, and so on.

This all facilitates, e.g., the expansion of the number of functions that can be controllable via a hands-free device, and, furthermore, the inclusion of more complex functions on a hands-free device. It also facilitates later and subsequent addition of new functions to the hands-free device as part of the menu structure.

1. A hands-free device for a communications device, comprising: means for providing a spoken prompt to a user via the hands-free device.

2. The hands-free device of claim 1, wherein the means for providing a spoken prompt to a user further comprises means for providing spoken prompts regarding at least one function operable via the hands-free device.

3. The hands-free device of claim 1, wherein the means for providing a spoken prompt to a user further comprises means for providing spoken prompts regarding a status or condition of one of the group consisting of the hands-free device, the communications device, and a communications network to which the communications device is coupled.

4. The hands-free device of claim 1, further comprising means for providing the spoken prompt in response to the occurrence of particular events.

5. The hands-free device of claim 1, further comprising:
means for detecting operation of a user-operable input means of the hands-free device; and
means for providing, in response to detecting operation of a user-operable input means of the hands-free device, the spoken prompt to the user.

6. A hands-free device for a communications device, comprising:
means for providing, in response to detecting operation of a user operable input means of the hands-free device, a spoken prompt to a user of the hands-free device.

7. The hands-free device of claim 5, wherein the spoken prompt provided relates solely to a function that can be activated by the user-operable input in question.

8. The hands-free device of claim 6, wherein the user-operable input means and spoken prompts are arranged such that a first operation of the input means triggers the spoken prompt, and a second operation or activation of the input means activates a relevant function.

9. A hands-free device for a communications device, comprising:
means for detecting operation of a user-operable input means of the hands-free device;
means for providing in response to such detection a spoken prompt to a user of the hands-free device;
means for activating, in response to detecting a subsequent operation of the user-operable input means of the hands-free device, a function provided by the user-operable input means.

10. The hands-free device of claim 9, further comprising means for storing a plurality of spoken prompts that may be broadcast in use.

11. The hands-free device of claim 9, wherein the function of the hands-free device is arranged in a menu structure that can be navigated using at least one input of the hands-free device to activate the function.

12. The hands-free device of claim 11, wherein a plurality of functions are provided by the hands-free device arranged in multiple sets of selectable functions, with each set of the functions comprising a loop of the functions that can be navigated around and selected from.

13. The hands-free device of claim 12, wherein in each function set, a given function option will perform one activity from the group consisting of:
activate a function of the hands-free device; and
move the user to another set of functions that can be selected from.

14. The hands-free device of claim 11, further comprising:
means for providing the spoken prompt relating to each function as the user navigates to the respective function in the menu structure.

15. The hands-free device of claim 9, further comprising:
means for providing the spoken prompt to the user in such a way that the spoken prompt appears to have a spatial position relative to at least one of the user and the hands-free device.

16. The hands-free device of claim 9, further comprising:
means for varying the volume of the spoken prompt prompts.

17. The hands-free device of claim 9, wherein spoken prompt can be selectively disabled for at least one function operable via the hands-free device.

18. An apparatus for providing a user interface for an electronic device, comprising:
means for providing to a user of the electronic device at least one spoken prompt that appear to come from different locations relative to the electronic device.

19. An apparatus for providing a user interface for an electronic device, comprising:
means for arranging user-selectable commands and functions of the electronic device in a menu-structure; and
user-operable input means via which the user may navigate through the menu-structure to select a desired function of the electronic device;
wherein, in the menu-structure, a plurality of sets of functions of the device are arranged as endless loops around which the user may navigate using the user-operable input means of the device, and the arrangement of the sets of functions is such that the user may navigate between the sets of functions using the user-operable input means of the device.

20. A method of operating a hands-free device for a communications device, comprising:
providing a spoken prompt to a user of the hands-free device from the hands free device.

21. The method of claim 20, further comprising providing spoken prompts from the hands-free device regarding at least one function operable via the hands-free device.

22. The method of claim 20, further providing spoken prompts from the hands-free device regarding a status of at least one of the hands-free device, the communications device, and a communications network to which the communications device is coupled.

23. The method of claim 20, further comprising providing the spoken prompt from the hands-free device in response to the occurrence of particular events.

24. The method of claim 20, further comprising:
detecting operation of a user-operable input means of the hands-free device; and
providing in response to such detection the spoken prompt to the user.

25. A method of operating a hands-free device for a communications device, comprising:
detecting operation of a user-operable input means of the hands-free device; and
providing in response to such detection a spoken prompt from the hands-free device to a user of the hands-free device.

26. The method of claim 25, wherein the spoken prompt relates solely to the function that can currently be activated by the user-operable input means.

27. The method of claim 25, wherein the user-operable input means and the spoken prompt are arranged such that a first operation of the input means triggers the spoken prompt, and a second operation of the input means activates the relevant function.

28. A method of operating a hands-free device for a communications device, the method comprising the hands-free device:
detecting operation of a user-operable input means of the hands-free device;
providing in response to such detection a spoken prompt to a user of the hands-free device;
detecting a subsequent operation of the user-operable input means of the hands-free device; and
activating in response to detection of the subsequent operation of the user-operable input means a function provided by the user-operable input means.

29. The method of claim 28, comprising storing a set of spoken prompts that may be broadcast in use.

30. The method of claim 28 wherein a plurality of functions of the hands-free device are arranged in a menu structure that can be navigated through using at least one input of the hands-free device to activate the functions.

31. The method of claim 30, wherein the plurality of functions provided by the hands-free device are arranged in multiple sets of selectable functions, with each set of functions comprising a loop of functions that can be navigated around and selected from.

32. The method of claim 31, wherein in each of the sets of selectable functions, a given selection will perform at least one of activating an operation of the hands-free device; and moving the user to another of the sets of functions that can be selected from.

33. The method of claim 30, further comprising:
providing a spoken prompt relating to at least one of the function as and when the user navigates to the respective function in the menu structure.

34. The method of claim 30, further comprising:
providing a plurality of spoken prompts to a user in such a way that the spoken prompts appear to have a spatial position or orientation relative at least one of to the user and the hands-free device.

35. The method of claim 33, further comprising:
varying the volume of the spoken prompt.

36. The method of claim 33, further comprising selectively disabling the spoken prompt for at least one function operable via the hands-free device.

37. A method of providing a user interface for an electronic device, comprising:
providing a plurality spoken prompts to a user of the electronic device such that different spoken prompts appear to come from different positions relative to the electronic device.

38. A method of providing a user interface for an electronic device, comprising:
arranging user-selectable commands and functions of the electronic device in a menu-structure through which a user may navigate to select a desired function of the electronic device using a user-operable input means of the electronic device;
wherein, in the menu-structure, sets of functions of the electronic device are arranged as endless loops around which the user may navigate, and an arrangement of the functions is such that the user may navigate between the sets of functions using the user-operable input means of the electronic device.

39. A computer program element comprising computer software code portions for performing the method of claim 28 when the program element is run on a data processing means.

40-43. (canceled)
